(19) United States
(12) Patent Application Publication
(10) Pub. No.: US 2010/0092863 A1
(43) Pub. Date: Apr. 15, 2010

(54) Non-aqueous electrolyte for secondary battery and secondary battery including the same

(76) Inventor: Jinbum Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/588,300

(22) Filed: Oct. 9, 2009

(30) Foreign Application Priority Data
Oct. 13, 2008 (KR) 2008-100006

(51) Int. Cl. H01M 10/26

(52) U.S. Cl. 429/207

(57) ABSTRACT

A non-aqueous electrolyte for a secondary battery and a secondary battery comprising the non-aqueous electrolyte. The non-aqueous electrolyte includes a non-aqueous organic solvent, a lithium salt, and as an additive, a compound represented by Formula 1:

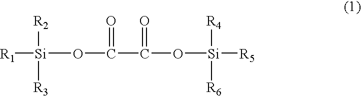

wherein R₁ to R₆, which may be the same or different from each other, are selected from substituted and unsubstituted C₁-C₄ alkyl, alkoxy and alkenyl groups. The secondary battery has excellent cycle life characteristics and high discharge capacity at low temperature.

### CROSS-REFERENCE TO RELATED APPLICATION

This application claims the benefit of Korean Patent Application No. 2008-100006, filed Oct. 13, 2008 in the Korean Intellectual Property Office, the entire disclosure of which is incorporated herein by reference.

### BACKGROUND OF THE INVENTION

1. Field of the Invention

Aspects of the present invention relate to a non-aqueous electrolyte for a secondary battery, and to a secondary battery.

2. Description of the Related Art

A typical lithium ion secondary battery has an average discharge voltage of 3.6 to 3.7 V, which enables the production of higher power than other alkaline batteries such as Ni-MH and Ni—Cd batteries. To attain such a high driving voltage, the lithium ion secondary battery needs an electrolyte composition that is electrochemically stable in the charge/discharge voltage range of 0 to 4.2 V. To meet this need, for example, a mixture containing a cyclic carbonate such as ethylene carbonate, propylene carbonate or butylene carbonate as a solvent is currently used as the electrolyte.

In a lithium-ion secondary battery, lithium ions migrate from a lithium oxide of a positive electrode to carbon of a negative electrode and are intercalated into the carbon during the initial charge. The lithium ions react with the carbon of the negative electrode due to their high reactivity. As a result of the reaction, Li₂CO₃, Li₂O, LiOH, etc, are created to leave a film, called a solid electrolyte interface (SEI) film, on the surface of the negative electrode. The SEI film formed during the initial charging of the battery blocks the lithium ions from reacting with the carbon of the negative electrode or other materials during subsequent repeated charging/discharging of the battery and acts as an ion tunnel through which only the lithium ions pass. Organic solvents having a high molecular weight present in an electrolyte migrate while solvating the lithium ions and are intercalated into the carbon of the negative electrode to disrupt the structure of the carbon of the negative electrode. The ion tunnel plays a role in protecting the negative electrode from structural disruption by the organic solvents.

As the charge/discharge cycles proceed, however, the electrode plates undergo repeated expansion and shrinkage and partial overvoltage. These phenomena gradually disrupt the SEI film as a passivation layer with the passage of time to induce continuous side reactions between the surrounding electrolyte and the exposed surface of the negative electrode. Depending on the kind of graphite negative electrode active materials used, the carbonate-based electrolyte is decomposed and the carbon material tends to peel, resulting in a deterioration in the battery characteristics, such as electrical capacity, cycle characteristics and storage characteristics. Such deterioration is particularly noticeable in electrolytes containing propylene carbonate. Propylene carbonate is decomposed in the graphite negative electrode during the initial charge, resulting in a marked reduction in the initial capacity.

Japanese Unexamined Patent Publication No. Hei 8-45545 discloses a technique for inhibiting the decomposition of an electrolyte by the addition of vinylene carbonate to propylene carbonate and ethylene carbonate. The use of vinylene carbonate is effective in improving the life characteristics of a battery, but greatly reduces the discharge capacity of the battery at low temperature and causes severe swelling of the battery during storage at high temperature.

### SUMMARY OF THE INVENTION

Aspects of the present invention provide a non-aqueous electrolyte for a secondary battery that uses an additive capable of forming a perfect SEI film during the initial charge to achieve excellent cycle life characteristics of the battery and prevent a reduction in the low-temperature discharge capacity of the battery.

Another aspect of the present invention provides a secondary battery comprising the non-aqueous electrolyte.

An embodiment of the present invention provides a non-aqueous electrolyte for a secondary battery that comprises a non-aqueous organic solvent, a lithium salt, and as an additive, a compound represented by Formula 1:

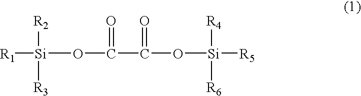

wherein R₁ to R₆, which may be the same or different from each other, are selected from substituted and unsubstituted C₁-C₄ alkyl, alkoxy and alkenyl groups.

Another embodiment of the present invention provides a secondary battery comprising the non-aqueous electrolyte, a positive electrode containing a positive electrode active material, a negative electrode containing a negative electrode active material, and a separator disposed between the positive and negative electrodes.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a graph showing changes in the discharge capacity of batteries fabricated in Examples 1-7 and Comparative Examples 1-2 with increasing number of charge/discharge cycles in cycle life tests of the batteries.

### DETAILED DESCRIPTION OF THE EMBODIMENTS

Hereinafter, exemplary embodiments of the present invention will be described in detail with reference to the accompanying drawing.

Aspects of the present invention provide a non-aqueous electrolyte for a secondary battery that comprises a non-aqueous organic solvent, a lithium salt and an additive.

In an embodiment, the additive may be a compound represented by Formula 1:

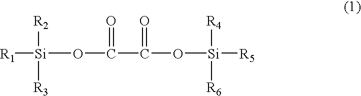

wherein R₁ to R₆, which may be the same or different from each other, are selected from a substituted or unsubstituted C₁-C₄ alkyl group, a substituted or unsubstituted C₁-C₄ alkoxy group and a substituted or unsubstituted C₁-C₄ alkenyl group.

When the non-aqueous electrolyte of an embodiment of the present invention is applied to a secondary battery, a stable SEI film is formed during the initial charge due to the use of the compound of Formula 1 as an additive to achieve an extended cycle life and increased discharge capacity at low temperatures (−20-0° C.).

In an embodiment, the compound of Formula 1 may be bis(trimethylsilyl) oxalate of Formula 2:

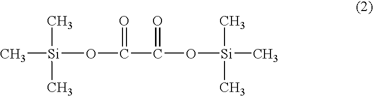

Bis(trimethylsilyl) oxalate of Formula 2 is the compound of Formula 1 wherein R₁ to R₆ are all methyl.

In an embodiment, the compound of Formula 1 may be present in an amount of 0.1 to 5% by weight, based on the total weight of the non-aqueous electrolyte. If the compound of Formula 1 is used in an amount of less than 0.1% by weight, sufficient extension of cycle life cannot be attained and an improvement in low-temperature discharge characteristics cannot be expected. If the compound of Formula 1 is used in an amount of more than 5% by weight, an SEI film is formed to be too thick or the unreacted remaining components function as resistors during discharge at low temperature, causing a degradation in performance. More preferably, the compound of Formula 1 may be present in an amount of 0.1 to 2.0% by weight, based on the total weight of the non-aqueous electrolyte. When the compound of Formula 1 is used in an amount of more than 2.0% by weight, a further extension in cycle life is not so significant, compared with the cycle life achieved from the amount of 2.0% by weight.

The non-aqueous organic solvent acts as a medium through which ions involved in the electrochemical reactions of the battery can migrate. Any of the non-aqueous organic solvents known to those skilled in the art can be used in the present invention.

In an embodiment, the non-aqueous organic solvent may be selected from the group consisting of cyclic carbonates, acyclic carbonates, aliphatic carboxylic acid esters, acyclic ethers, cyclic ethers, alkyl phosphoric acid esters, and fluorides thereof.

Examples of the cyclic carbonates include ethylene carbonate, propylene carbonate, butylene carbonate and vinylene carbonate. Examples of the acyclic carbonates include dimethyl carbonate, diethyl carbonate, ethyl methyl carbonate, methyl propyl carbonate, ethyl propyl carbonate, dipropyl carbonate and methyl ethyl carbonate. Examples of the aliphatic carboxylic acid esters include methyl formate, methyl acetate, methyl propionate and ethyl propionate. Examples of the acyclic ethers include γ-lactones, 1,2-dimethoxyethane, 1,2-diethoxyethane and ethoxymethoxyethane. Examples of the cyclic ethers include tetrahydrofuran and 2-methyltetrahydrofuran. Examples of the alkyl phosphoric acid esters include dimethylsulfoxide, 1,2-dioxolane, trimethyl phosphate, triethyl phosphate and trioctyl phosphate. These non-aqueous organic solvents may be used alone or as a mixture of two or more thereof.

The lithium salt is a source of lithium ions and enables the basic operation of the lithium battery. In an embodiment, the lithium salt may be selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, Lil, and mixtures thereof.

In an embodiment, the lithium salt may be present at a concentration of 0.6 to 2.0 M and preferably 0.7 to 1.6 M. If the concentration of the lithium salt is less than 0.6 M, the conductivity of the electrolyte is low, resulting in a deterioration in the performance of the electrolyte. If the concentration of the lithium salt is more than 2.0 M, the electrolyte is viscous, resulting in a decrease in the mobility of the lithium ions.

In another embodiment, the non-aqueous electrolyte of the present invention may further comprise other additives commonly used in electrolytes for secondary batteries so long as the effects of the present invention are not sacrificed.

Aspects of the present invention also provide a secondary battery comprising the non-aqueous electrolyte.

Specifically, the secondary battery of the present invention comprises the non-aqueous electrolyte, a positive electrode, a negative electrode and a separator.

The positive electrode contains a positive electrode active material capable of reversible intercalation/deintercalation of lithium ions. The positive electrode active material is preferably a composite metal oxide of lithium and at least one metal selected from cobalt, manganese and nickel. There is no particular restriction on the ratio of the metals employed. In addition to these metals, at least one element selected from the group consisting of Mg, Al, Co, K, Na, Ca, Si, Ti, Sn, V, Ge, Ga, B, As, Zr, Mn, Cr, Fe, Sr, V and rare earth elements may be further included in the positive electrode active material.

The negative electrode includes a negative electrode active material capable of reversible intercalation/deintercalation of lithium ions. The negative electrode active material may be a carbonaceous negative electrode active material, such as crystalline or amorphous carbon, a carbon composite (e.g., thermally decomposed carbon, coke or graphite), a sintered organic polymer compound, a carbon fiber, a tin oxide compound, a lithium metal, or a lithium alloy.

Examples of the amorphous carbon include hard carbon, coke, mesocarbon microbeads (MCMBs) calcined at 1,500° C. or less, and mesophase pitch-based carbon fibers (MPCFs). The crystalline carbon is a graphite-based material, and specific examples thereof include natural graphite, graphitized coke, graphitized MCMBs and graphitized MPCFs. In an embodiment, the carbon material has an interplanar distance of 3.35 to 3.38 Å and a crystallite size (Lc) of at least 20 nm, as determined by X-ray diffraction. Examples of the lithium alloy includes alloys comprised of lithium and other metal(s) such as aluminum, zinc, bismuth, cadmium, antimony, silicon, lead, tin, gallium and indium.

The separator serves to prevent shorting between the positive and negative electrodes. Any number of materials may be used as the separator, and examples thereof include polymer membranes, such as polyolefin, polypropylene and polyethylene membranes, multiple membranes thereof, microporous films, woven fabrics and non-woven fabrics.

The secondary battery of aspects of the present invention may have the following cell structures: a unit cell comprised of positive electrode/separator/negative electrode, a bicell comprised of positive electrode/separator/negative electrode/separator/positive electrode, and a laminate cell comprised of two or more repeating unit cells.

Hereinafter, the present invention will be explained in detail with reference to the following examples, including comparative examples. However, these examples are given merely for the purpose of illustration and are not intended to limit the present invention.

### EXAMPLES

### Example 1

LiCoO₂ as a positive electrode active material, polyvinylidene fluoride (PVdF) as a binder and carbon as a conductive material were mixed in a weight ratio of 92:4:4, and then the mixture was dispersed in N-methyl-2-pyrrolidone to prepare a slurry. The slurry was coated to a thickness of 20 μm on an aluminum foil, dried and rolled to produce a positive electrode. Artificial graphite as a negative electrode active material, styrene-butadiene rubber as a binder and carboxymethyl cellulose as a thickener were mixed in a weight ratio of 96:2:2 and dispersed in water to prepare a slurry. The slurry was coated to a thickness of 15 μm on a copper foil, dried and rolled to produce a negative electrode.

A 20 μm-thick polyethylene (PE) film as a separator was positioned between the electrodes, and the three layers were wound, pressed together and inserted into a prismatic can.

LiPF₆ was added to a mixed solvent of ethylene carbonate, ethyl methyl carbonate and diethyl carbonate (2:2:6 (v/v/v)) until the LiPF₆ concentration reached 1.3 M, and bis(trimethylsilyl) oxalate of Formula 2 was added thereto to prepare a non-aqueous electrolyte. Then, the compound of Formula 2 was added in an amount of 0.2% by weight, based on the total weight of the non-aqueous electrolyte. The non-aqueous electrolyte was injected into the can to fabricate a lithium secondary battery.

### Example 2

A lithium secondary battery was fabricated in the same manner as in Example 1, except that bis(trimethylsilyl) oxalate was added in an amount of 0.5% by weight, based on the total weight of the non-aqueous electrolyte.

### Example 3

A lithium secondary battery was fabricated in the same manner as in Example 1, except that bis(trimethylsilyl) oxalate was added in an amount of 0.8% by weight, based on the total weight of the non-aqueous electrolyte.

### Example 4

A lithium secondary battery was fabricated in the same manner as in Example 1, except that bis(trimethylsilyl) oxalate was added in an amount of 1.0% by weight, based on the total weight of the non-aqueous electrolyte.

### Example 5

A lithium secondary battery was fabricated in the same manner as in Example 1, except that bis(trimethylsilyl) oxalate was added in an amount of 1.5% by weight, based on the total weight of the non-aqueous electrolyte.

### Example 6

A lithium secondary battery was fabricated in the same manner as in Example 1, except that bis(trimethylsilyl) oxalate was added in an amount of 2.0% by weight, based on the total weight of the non-aqueous electrolyte.

### Example 7

A lithium secondary battery was fabricated in the same manner as in Example 1, except that bis(trimethylsilyl) oxalate was added in an amount of 3.0% by weight, based on the total weight of the non-aqueous electrolyte.

### Comparative Example 1

A lithium secondary battery was fabricated in the same manner as in Example 1, except that bis(trimethylsilyl) oxalate was not added.

### Comparative Example 2

A lithium secondary battery was fabricated in the same manner as in Example 1, except that 3.0% by weight of vinyl carbonate (VC) was used instead of bis(trimethylsilyl) oxalate.

<Cycle Life Test>

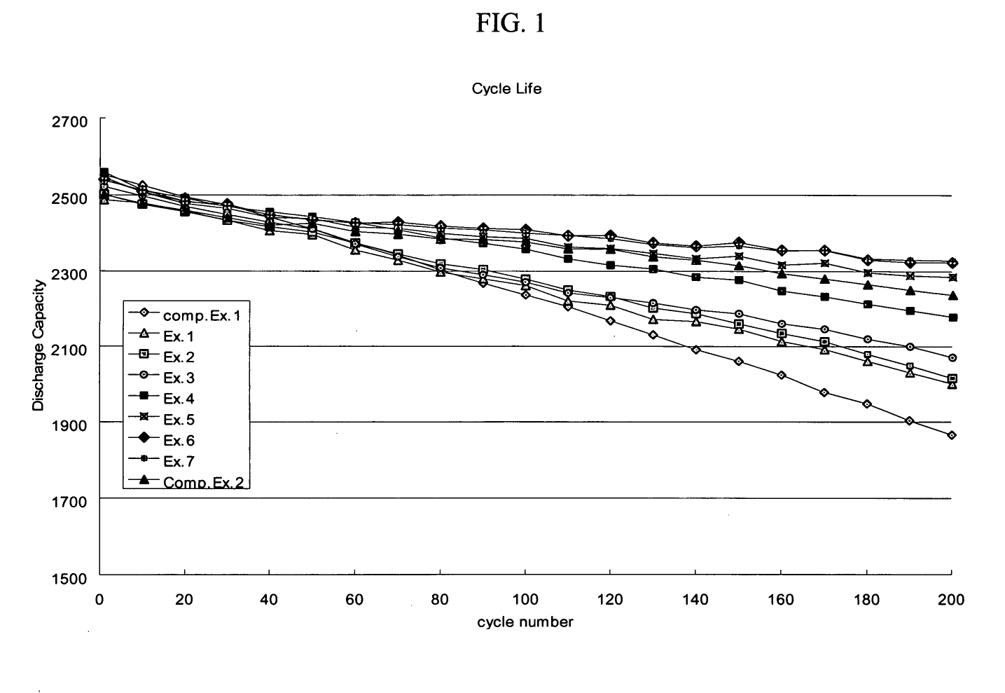

The batteries (capacity ˜2,600 mAh) fabricated in Examples 1-7 and Comparative Examples 1-2 were charged with a constant current of 0.8 C at room temperature until their voltages reached 4.2 V and thereafter, the batteries were charged with a constant voltage of 4.2 V until their currents reached 100 mA. After completion of the charging, the batteries were allowed to stand for 10 minutes. The batteries were discharged with a constant current of 1 C until their voltages dropped to 3.0 V. After 200 cycles of charging and discharging, the discharge capacity of each battery was measured, and the ratio of the discharge capacity after 200 cycles to the discharge capacity at the first cycle was calculated. The results are shown in Table 1 and FIG. 1. In these experimental examples, ‘C’ is a unit of ‘C-rate’ that is a charge or discharge current normalized to battery capacity. A charge or discharge rate of one C draws a capacity equal to the battery capacity in one hour. That is, 1C in the batteries (capacity ˜2,600 mAh) fabricated in Examples 1-7 and Comparative Examples 1-2 corresponds to a current of ˜2.6 A.

<Low-Temperature Discharge Capacity Test>

The batteries (capacity=˜2,600 mAh) fabricated in Examples 1-7 and Comparative Examples 1-2 were charged with a constant current of 0.5 C at room temperature until their voltages reached 4.2 V and thereafter, the batteries were charged with a constant voltage of 4.2 V until their currents reached 100 mA. After completion of the charging, the batteries were allowed to stand for 10 minutes. After the batteries were discharged with a constant current of 0.2 C at −10° C. until their voltages reached 3 V, the capacities were measured and compared with those measured at 25° C. The results are shown in Table 1.

TABLE 1

| | | Discharge capacity | Discharge Capacity |
|---|---|---|---|
| | Additive | after 200 cycles/ | at −10° C./ |
| | content | Discharge capacity at | Discharge Capacity |
| | (wt %) | the first cycle (%) | at 25° C. (%) |
| Example 1 | 0.2 | 78.5 | 79.8 |
| Example 2 | 0.5 | 79.0 | 80.1 |
| Example 3 | 0.8 | 81.2 | 83.1 |
| Example 4 | 1.0 | 85.4 | 85.8 |
| Example 5 | 1.5 | 89.6 | 84.5 |
| Example 6 | 2.0 | 91.1 | 83.1 |
| Example 7 | 3.0 | 91.3 | 79.5 |
| Comparative | 0 | 73.2 | 75.4 |
| Example 1 | | | |
| Comparative | VC (3) | 87.7 | 76.1 |
| Example 2 | | | |

As can be seen from the results in Table 1, the batteries of Examples 1-7, each of which was fabricated using the non-aqueous electrolyte containing bis(trimethylsilyl) oxalate as an additive, showed significantly increased cycle life and low-temperature discharge characteristics when compared to the battery of Comparative Example 1, which was fabricated using the electrolyte containing no additive.

There were no significant differences between the batteries of Examples 6 and 7 in cycle life and low-temperature discharge characteristics despite the use of a larger amount of bis(trimethylsilyl) oxalate in the battery of Example 7. These results lead to the conclusion that it is preferable to use bis(trimethylsilyl) oxalate in an amount of 2% by weight or less.

The battery of Comparative Example 2, which was fabricated using the electrolyte containing vinyl carbonate as an additive, showed good cycle life characteristics but was found to have poor low-temperature discharge characteristics. When Example 7 wherein 3.0% by weight of bis(trimethylsilyl) oxalate was added is compared with Comparative Example 2 wherein 3.0% by weight of vinyl carbonate (VC) was added, Example 7 showed significant improved results in the discharge capacity as well as the cycle life characteristics.

As is apparent from the above description, when the non-aqueous electrolyte of these aspects of the present invention is applied to a secondary battery, a good SEI film is formed during the initial charge due to the use of the compound of Formula 1 as an additive to achieve extended cycle life and increased discharge capacity at low temperature.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A non-aqueous electrolyte for a secondary battery, comprising
a non-aqueous organic solvent,
a lithium salt, and
an additive represented by Formula 1: 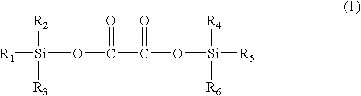
wherein R₁ to R₆, which are the same or different from each other, are independently selected from the group consisting of a substituted or unsubstituted C₁-C₄ alkyl group, a substituted or unsubstituted C₁-C₄ alkoxy group and a substituted or unsubstituted C₁-C₄ alkenyl group.

2. The electrolyte of claim 1, wherein the additive of Formula 1 is bis(trimethylsilyl) oxalate of Formula 2:

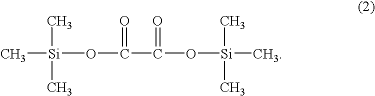

3. The electrolyte of claim 1, wherein the additive of Formula 1 is present in an amount of 0.1 to 5% by weight, based on the total weight of the non-aqueous electrolyte.

4. The electrolyte of claim 1, wherein the additive of Formula 1 is present in an amount of 0.1 to 2% by weight, based on the total weight of the non-aqueous electrolyte.

5. The electrolyte of claim 1, wherein the non-aqueous organic solvent is selected from the group consisting of cyclic carbonates, acyclic carbonates, aliphatic carboxylic acid esters, acyclic ethers, cyclic ethers, alkyl phosphoric acid esters, fluorides thereof, and mixtures thereof.

6. The electrolyte of claim 1, wherein the lithium salt is selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, Lil, and mixtures thereof.

7. A secondary battery comprising the non-aqueous electrolyte of claim 1, a positive electrode, a negative electrode, and a separator disposed between the positive electrode and the negative electrode.

8. A secondary battery, comprising:
a positive electrode containing a positive electrode active material;
a negative electrode containing a negative electrode active material; and
an electrolyte comprising:
a non-aqueous organic solvent,
a lithium salt, and
an additive represented by Formula 1: 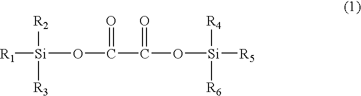
wherein R₁ to R₆, which are the same or different from each other, are independently selected from the group consisting of a substituted or unsubstituted C₁-C₄ alkyl group, a substituted or unsubstituted C₁-C₄ alkoxy group, and a substituted or unsubstituted C₁-C₄ alkenyl group.

9. The secondary battery of claim 8, wherein the additive of Formula 1 is bis(trimethylsilyl) oxalate of Formula 2:

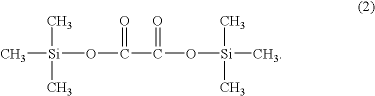

10. The secondary battery of claim 8, wherein the additive of Formula 1 is present in an amount of 0.1 to 5% by weight, based on the total weight of the non-aqueous electrolyte.

11. The secondary battery of claim 8, wherein the additive of Formula 1 is present in an amount of 0.1 to 2% by weight, based on the total weight of the non-aqueous electrolyte.

12. The secondary battery of claim 8, wherein the non-aqueous organic solvent is selected from the group consisting of cyclic carbonates, acyclic carbonates, aliphatic carboxylic acid esters, acyclic ethers, cyclic ethers, alkyl phosphoric acid esters, fluorides thereof, and mixtures thereof.

13. The secondary battery of claim 8, wherein the lithium salt is selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, Lil, and mixtures thereof.

14. A secondary battery, comprising:
a positive electrode containing a positive electrode active material;
a negative electrode containing a negative electrode active material;
a separator interposed between the positive electrode and the negative electrode; and
an electrolyte comprising:
a non-aqueous organic solvent,
a lithium salt, and
an additive represented by Formula 1: 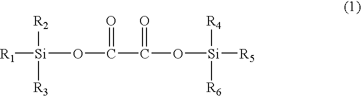
wherein R₁ to R₆, which are the same or different from each other, are independently selected from the group consisting of a substituted or unsubstituted C₁-C₄ alkyl group, a substituted or unsubstituted C₁-C₄ alkoxy group, and a substituted or unsubstituted C₁-C₄ alkenyl group; and
the additive of Formula 1 is present in an amount of 0.1 to 5% by weight, based on the total weight of the non-aqueous electrolyte.

15. The secondary battery of claim 14, wherein the additive of Formula 1 is wherein R₁ to R₆ are alkyl groups.

16. The secondary battery of claim 14, wherein the additive of Formula 1 is wherein R₁ to R₆ are methyl groups.

17. The secondary battery of claim 14, wherein the additive of Formula 1 is wherein R₁ to R₆ are C₁-C₄ alkyl groups.

18. The secondary battery of claim 14, wherein the additive of Formula 1 is wherein R₁ to R₆ are C₁-C₄ alkenyl groups.

19. The secondary battery of claim 14, wherein the non-aqueous organic solvent is selected from the group consisting of cyclic carbonates, acyclic carbonates, aliphatic carboxylic acid esters, acyclic ethers, cyclic ethers, alkyl phosphoric acid esters, fluorides thereof, and mixtures thereof.

20. The secondary battery of claim 14, wherein the lithium salt is selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, Lil, and mixtures thereof.
